(19) United States
(12) Patent Application Publication
(10) Pub. No.: US 2017/0024916 A1
(43) Pub. Date: Jan. 26, 2017

(54) MEDIA COMPOSITION USING AGGREGATE OVERLAY LAYERS

(71) Applicant: Microsoft Technology Licensing, LLC, Redmond, WA (US)

(72) Inventors: Radhika S. Jandhyala, Redmond, WA (US); Li Li, Redmond, WA (US); Xin Xin, Redmond, WA (US); Qirong Ma, Seattle, WA (US); Jason Olson, Kirkland, WA (US)

(21) Appl. No.: 14/804,468

(22) Filed: Jul. 21, 2015

(51) Int. Cl. G06T 11/60

(52) U.S. Cl. CPC G06T 11/60

(57) ABSTRACT

Techniques and constructs for media composition using aggregate overlay layers. For instance, a media compositor receives a media source and at least two media overlays, where each of the at least two media overlays are to be composed with the media source. The media compositor then generates an output media composition by adding each of the at least two media overlays to the media source in a single processing step. In some examples, the media compositor adds the at least two media overlays to the media source using a preconfigured compositor. In other examples, the media compositor adds the at least two media overlays to the media source using a custom compositor.

### BACKGROUND

Video editing applications are becoming a key attraction for users of computing devices. For instance, with increased capabilities of mobile devices, more and more users are enjoying the benefits of creating videos on their mobile devices. When creating videos, the users of these mobile devices are able to record or otherwise access videos on their mobile devices and edit the videos using simple editing tools.

However, consumer video editing is currently resource intensive and can be cumbersome from a user perspective. For example, when creating a composite video, current application programming interfaces (APIs) for video editing only allow users to render media overlays to a source video one at a time. As a result, the amount of processing that is required to compose a composite video that includes more than one media overlay increases as the number of media overlays increases.

### SUMMARY

This disclosure describes systems and methods for media composition using aggregate overlay layers. In at least one example, a media compositor receives a media source and at least two media overlays, where each of the at least two media overlays are to be composed with the media source. The media compositor then generates an output media composition by grouping the at least two media overlays together and adding the at least two media overlays to the media source in a single processing step.

In one example, the media compositor performs straightforward media composition based on pre-defined or user-submitted overlay parameters. In another example, the media compositor provides tools (e.g., application programming interfaces (APIs)) that enable a developer to create a custom composition module to support more complex media composition. For example, a custom composition module may support media compositions that includes complex overlays that may be controlled at the frame level of the media source.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram illustrating an example environment for implementing media composition using aggregate overlay layers, as described herein.

FIG. 2 is a block diagram illustrating an example computing device configured to support media composition using aggregate media layers.

FIG. 3 is a block diagram illustrating an example pipeline for implementing media composition using aggregate overlay layers.

FIG. 4 is a flow diagram of an example method for performing media composition using aggregate overlay layers.

FIG. 5 is a flow diagram of an example method for generating a media composition based at least in part on overlay parameters.

FIG. 6 is a flow diagram of an example method for performing media composition using a custom composition module.

FIG. 7 is a flow diagram of an example method for processing a request to generate a media composition using a media compositor.

### DETAILED DESCRIPTION

### Overview

Examples described herein provide techniques to improve media composition by introducing a layered design to media composition that enables both preconfigured (i.e., static) media overlay and custom (i.e., dynamic) media overlay. For example, in some cases, developers want to perform straightforward media composition by merely providing select parameters for media overlays that are to be added to a media source. In other cases, an application developer may want the application to support complex media composition by, for example, controlling individual frames of the media source and individual frames of the media overlays in order to create a more complex media composition. In either case, the layered design to media composition provides both simplicity and flexibility.

For example, an application may enable a user to create a straightforward media composition that includes a media source (e.g., video), a first media overlay (e.g., graphic), and a second media overlay (e.g., text). Using a preconfigured composition module, the application merely provides the media compositor with the media source, the first media overlay, and the second media overlay. The media compositor generates a media composition by processing the media source, the first media overlay, and the second media overlay using the layered design according to a pre-defined processing pattern. For instance, the media compositor may generate the media composition by grouping the first media overlay with the second media overlay to create a single overlay layer that includes both the graphic and the text, and then adding the overlay layer to the media source in a single processing step. The pre-defined processing pattern may specify, for example, an animation or a frame transition, which is applied to the overlay layer. Accordingly, the pre-defined processing pattern is applied simultaneously to each media overlay that is part of the overlay layer. In this example, if the pre-defined processing pattern specifies a frame transition, the transition is applied to the overlay layer, and thus, is simultaneously applied to components of both the first media overlay and the second overlay.

In the example above, the media compositor may compose the first media overlay and the second media overlay with the media source using preconfigured parameters. The preconfigured parameters may include, for example, a timing, a position, and an opacity for composing media overlays with a media source. However, in another example, the application may also provide the media compositor with parameters that the media compositor then uses to generate the media composition. For instance, the user, and thus the application, may provide parameters that specify one or more of a timing, a position, and an opacity for composing the first media overlay with the media source and a timing, a position, and an opacity for composing the second media overlay with the media source. In either case, the preconfigured composition module of the media compositor provides the application with an efficient and straightforward technique for creating the media composition.

In another example, a media application developer may want to enable creation of a more complex media composition that again includes the media source (e.g., video), the first media overlay (e.g., graphic), and the second media overlay (e.g., text). In this scenario, a custom compositor development module provides the developer with the ability to create custom composition modules that that define custom processing patterns and that can plug into the media compositor. The media compositor then uses the custom composition plug-ins to generate the media composition.

For instance, the developer can generate a custom composition module that includes custom parameters for media composition. In an example, the custom parameters associate individual frames from the media source with individual frames from the first media overlay and individual frames from the second media overlay in any manner that the developer wishes. The custom composition module is implemented as a plug-in to the media compositor. A media composition can then be generated according to the custom processing pattern of the custom composition module based on the media source, the first media overlay, the second media overlay, and custom parameters expected by the custom composition module. As with the preconfigured composition module discussed above, the media compositor generates the custom media composition using a layered design by grouping the first media overlay and the second media overlay together and then adding the first media overlay and the second media overlay to the media source in a single processing step. For instance, the media compositor may add, based on the custom parameters, individual frames of the first media overlay and individual frames of the second media overlay to individual frames of the media source in a single processing step.

By providing simple and flexible application programming interfaces (APIs) to meet the developer's needs, the layered design techniques for media composition described herein require less processing resources than other techniques that developers use to create media compositions. For example, other APIs that developers use for media composition create the media composition by adding each media overlay to the media source one at a time, which requires processing the media source multiple times. In contrast, the layered design to media composition requires less processing resources to generate the media composition, since media overlays are grouped as a single layer and added to the media source in a single processing step.

As used herein, a “media compositor” is an executable software module that may be implemented, for example, as an application component or a component of an operating system. The media compositor includes a pre-configured composition module and any number of custom composition modules. The pre-configured composition module and the custom composition modules receive a media source (e.g., a background video or image) and any number of media overlays (e.g., text or images to be overlaid onto the media source). The composition module generates an output, which is referred to herein as a “media composition.” A media composition is the result of applying the media overlays to the media source.

As described herein, a media source may include a video (live or recorded), an image, a color, a graphics texture, or any other type of media that the media compositor can compose with a media overlay to create a media composition. Additionally, a media overlay may include a video (live or recorded), an image, a color, a graphics texture, a text, an animation, or any other type of media that the media compositor can compose with a media source to create the media composition.

It should be noted that more than one overlay layer can be further added to the media source. For example, a user may want to create a media composition that includes a media source and five media overlays. The media compositor can generate the media composition by grouping a first media overlay with a second media overlay to create a first overlay layer and grouping a third media overlay with a fourth media overlay and a fifth overlay to create a second overlay layer. The media compositor can then add the first overlay layer and the second overlay layer to the media source. For example, the media compositor can add the first overlay layer to the media source in a first processing step, generating a new media source, and then add the second media overlay to the new media source in a second processing step.

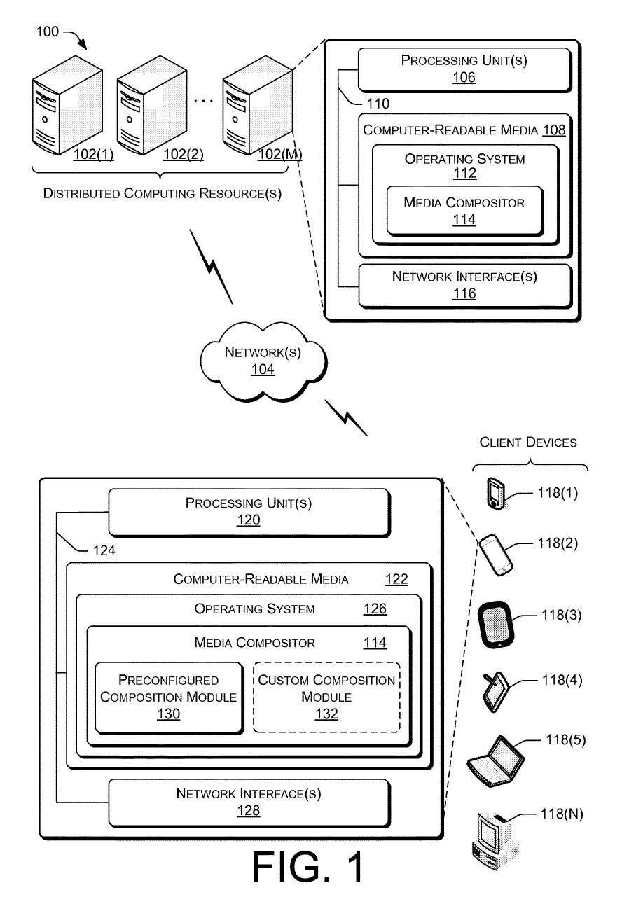

Various examples, scenarios, and aspects are described further with reference to FIGS. 1-7.

### Illustrative Environment

FIG. 1 shows an example environment 100 in which examples of media composition using aggregate overlay layers can operate. In some examples, the various devices and/or components of environment 100 include distributed computing resources 102 that can communicate with one another and with external devices via one or more networks 104.

Network(s) 104 can include, for example, public networks such as the Internet, private networks such as an institutional and/or personal intranet, or some combination of private and public networks. Network(s) 104 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 104 can utilize communications protocols, including packet-based and/or datagram-based protocols such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

In some examples, network(s) 104 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, distributed computing resources 102 include devices 102(1)-102(M). Examples support scenarios where device(s) 102 can include one or more computing devices that operate in a cluster or other grouped configuration to share resources, balance load, increase performance, provide fail-over support or redundancy, or for other purposes. Device(s) 102 can belong to a variety of categories or classes of devices such as traditional server-type devices, desktop computer-type devices, mobile-type devices, special purpose-type devices, embedded-type devices, and/or wearable-type devices. Thus, although illustrated as a single type of device, device(s) 102 can include a diverse variety of device types and are not limited to a particular type of device. Device(s) 102 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) 102 can include any computing device having one or more processing unit(s) 106 operably connected to computer-readable media 108 such as via a bus 110, which in some instances can include one or more of a system bus, a data bus, an address bus, a PCI bus, a Mini-PCI bus, and any variety of local, peripheral, and/or independent buses. Executable instructions stored on computer-readable media 108 can include, for example, an operating system 112, which includes media compositor 114, and other modules, programs, or applications that are loadable and executable by processing units(s) 106. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Device(s) 102 can also include one or more network interfaces 116 to enable communications between computing device(s) 102 and other networked devices such as client computing device(s) 118, which are configured to support rich media creation. Such network interface(s) 116 can include one or more network interface controllers (NICs) or other types of transceiver devices to send and receive communications over a network. For simplicity, other components are omitted from the illustrated device 102.

Other devices configured to support rich media creation can include client computing devices, for example one or more of devices 118(1)-118(N). Device(s) 118 can belong to a variety of categories or classes of devices, which can be the same as or different from device(s) 102, such as traditional client-type devices, desktop computer-type devices, mobile-type devices, special purpose-type devices, embedded-type devices, and/or wearable-type devices. Client computing device(s) 118 can include, but are not limited to, computer navigation type client computing devices 118(1) such as satellite-based navigation systems including global positioning system (GPS) devices and other satellite-based navigation system devices, telecommunication devices such as a mobile phone 118(2), a tablet computer 118(3), a mobile phone/tablet hybrid, a personal data assistant (PDA) 118(4), laptop computer 118(5), a personal computer 118(N), other mobile computers, wearable computers, implanted computing devices, desktop computers, automotive computers, network-enabled televisions, thin clients, terminals, game consoles, gaming devices, work stations, media players, personal video recorders (PVRs), set-top boxes, cameras, integrated components for inclusion in a computing device, appliances, or any other sort of computing device configured to support rich media creation.

Client computing device(s) 118 of the various categories or classes and device types such as the illustrated mobile phone 118(2) can represent any type of computing device having one or more processing unit(s) 120 operably connected to computer-readable media 122 such as via a bus 124, which in some instances can include one or more of a system bus, a data bus, an address bus, a PCI bus, a Mini-PCI bus, and any variety of local, peripheral, and/or independent buses.

Executable instructions stored on computer-readable media 122 can include, for example, an operating system 126, which includes media compositor 114, and other modules, programs, or applications that are loadable and executable by processing units(s) 120. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Client computing device(s) 120 can also include one or more network interfaces 128 to enable communications between client computing device(s) 118 and other networked devices such as other client computing device(s) 118 or device(s) 102 over network(s) 104. Such network interface(s) 128 can include one or more network interface controllers (NICs) or other types of transceiver devices to send and receive communications over a network.

In the example of FIG. 1, both operating system 112 of device(s) 102 and operating system 126 of client computing device(s) 118 are illustrated as including media compositor 114. However, in other examples, one or more of device(s) 102 and/or client computing device(s) 118 may include media compositor 114, or components thereof, stored as a separate application or application component in computer-readable media 108 and/or computer-readable media 122, respectively.

Additionally, in other examples, one or more of device(s) 102 and/or client computing device(s) 118 may not include media compositor 114. For example, client computing device(s) 1118 may not include media compositor 114. In such an example, client computing device(s) 118 may communicate with device(s) 102 over network 104 to perform the methods and processes described below. For instance, device(s) 102 may receive inputs (media sources, media overlays, parameters, etc.) from client computing device(s) 118 over network 104, process the inputs using media compositor 114, and then send outputs (media composition) to client computing device(s) 118 over network 104.

Whether implemented as part of a computing device 102 or a client computing device 118, example media compositor 114 includes a preconfigured composition module 130 and may also include one or more custom composition modules 132.

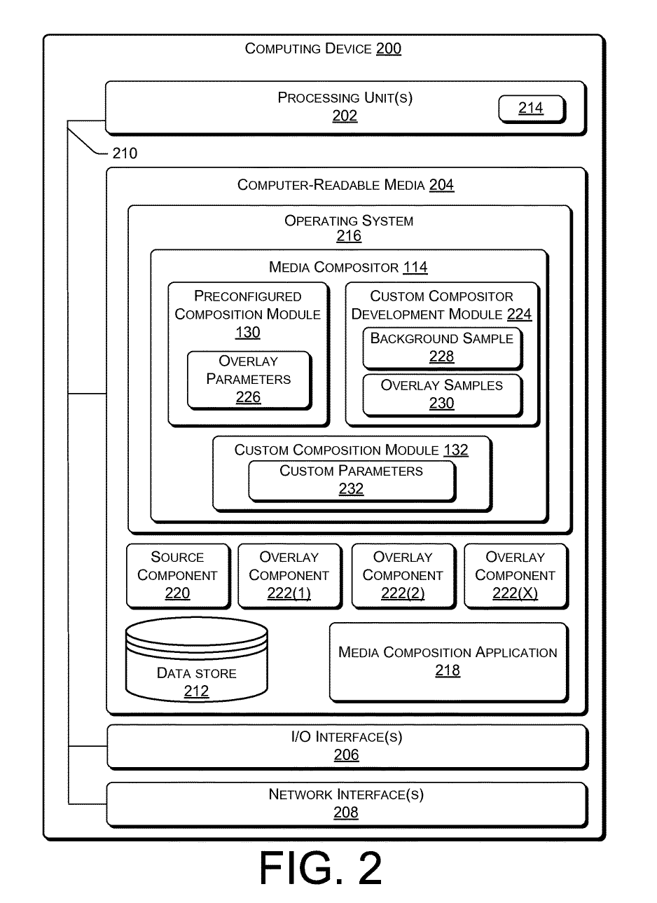

FIG. 2 is a block diagram depicting an example computing device 200, such as a device 102 and/or a client device 118 from FIG. 1. Example computing device 200 includes one or more processing unit(s) 202, computer-readable media 204, input/output interface(s) 206, and network interface(s) 208. The components of computing device 200 are operatively connected, for example, via a bus 210.

In example computing device 200, processing unit(s) 202 may correspond to processing unit(s) 106 and/or processing unit(s) 120 and can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

Computer-readable media 204 may correspond to computer-readable media 108 and/or computer-readable media 122 and can store instructions executable by the processing unit(s) 202. Computer-readable media 204 can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in device 200, while in some examples one or more of a CPU, GPU, and/or accelerator is external to device 200.

Computer-readable media may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Computer-readable media 108, 122, and/or 204 can be examples of computer storage media. Thus, the computer-readable media 1080, 122 and/or 204 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Input/output (I/O) interfaces 206 allow device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like).

Network interface(s) 208, which may correspond to network interface(s) 116 and/or network interface(s) 128, can represent, for example, network interface controllers (NICs) or other types of transceiver devices to send and receive communications over a network.

In the illustrated example, computer-readable media 204 also includes a data store 212. In some examples, data store 212 includes data storage such as a database, data warehouse, or other type of structured or unstructured data storage. In some examples, data store 212 includes a corpus and/or a relational database with one or more tables, indices, stored procedures, and so forth to enable data access including one or more of hypertext markup language (HTML) tables, resource description framework (RDF) tables, web ontology language (OWL) tables, and/or extensible markup language (XML) tables, for example. Data store 212 can store data for the operations of processes, applications, components, and/or modules stored in computer-readable media 204 and/or executed by processing unit(s) and/or accelerator(s) 202. Alternately, some or all of the above-referenced data can be stored on separate memories 214 on board one or more processing unit(s) 202 such as a memory on board a CPU-type processor, a GPU-type processor, an FPGA-type accelerator, a DSP-type accelerator, and/or another accelerator.

In the illustrated example, computer-readable media 204 also includes an operating system 216, which may correspond to operating system 112 and/or operating system 126. Computer-readable media 204 also includes a media composition application 218, a source component 220, and any number of overlay components 222. However, in other examples (not illustrated), one or more of source component 220 or overlay components 222 may be stored in and retrieved from data store 212 or from a data source external to computing device 200.

Operating system 216 includes media compositor 114, which includes one or more modules and/or APIs, such as preconfigured composition module 130, custom compositor development module 224, and any number of custom composition module(s) 132. Preconfigured composition module 130 is accessible to media composition applications to facilitate rich media creation. Custom compositor development module 224 provides tools (e.g. APIs) that enable a developer to create a custom composition module, such as custom composition module 132. Functionality described in association with blocks 130, 224, and 132 can be combined to be performed by a fewer number of modules and/or APIs or it can be split and performed by a larger number of modules and/or APIs.

Media composition application 218 provides an interface through which a user can specify media content to be combined to form a media composition. For example, a user may specify source component 220, overlay component 222(1) and overlay component 222(2) to be combined. In an example implementation, media composition application 218 accesses media compositor 114 to perform media composition.

Preconfigured composition module 130 includes logic to program processing unit 202 of device 200 to generate a media composition by adding media overlays to a media source using a layered design for media composition. For example, media composition application 218 provides media compositor 114 with a media source, such as source component 220. Source component 220 may include a video, an image, a graphic, a color, text, or the like. The application 218 may further provide media compositor 114 with multiple media overlays, such as overlay components 222(1), 222(2), . . . , 222(x). An overlay component 222 may include a video, an image, a graphic, a color, text, an animation, or the like.

In response to receiving source component 220 and overlay components 222, preconfigured composition module 130 generates a media composition. For example, preconfigured media composition module 130 groups overlay components 222 together to form a single overlay layer. Preconfigured media composition module 130 then adds the overlay layer to source component 220 in a single processing step. Unlike previous applications, which create a media composition by adding each overly component to the source component as a separate layer using its own processing step, the techniques described above require less processing because only one processing step is required for generating a media composition with multiple overlays.

As illustrated in FIG. 2, preconfigured media composition module 130 also supports overlay parameters 226. When adding overlay components 222 to source component 220, preconfigured media composition module 130 may add media components 222 to source component 220 based on overlay parameters 226. Overlay parameters 226 may include a timing, position, opacity, or the like that specify how preconfigured media composition module 130 is going to compose one or more of overlay components 222 with source component 220. For example, overlay parameters 226 may specify that overlay component 222(1) is to be composed at a top position over source component 220 from time zero to time thirty seconds with an opacity of fifty percent, overlay component 222(2) is to be composed at a bottom position over source component 220 from time fifteen seconds to time thirty seconds with an opacity of sixty percent, and overlay component 220(x) is to be composed at a left position over source component 220 from time twenty seconds to time forty seconds with an opacity of twenty percent.

In one example, overlay parameters 226 may be pre-defined within preconfigured composition module 130 so that an application only has to provide source component 220 and overlay components 222 to media compositor 114 for preconfigured composition module 130 to generate a media composition. In such an example, preconfigured composition module 130 may automatically set overlay parameters 226 for overlay components 222 when generating the media composition. However, in another example, the application may also provide preconfigured composition module 130 with overlay parameters 226 along with source component 220 and overlay components 222. For example, media composition application 218 may provide a user interface that allows a user to specify one or more overlay parameters while specifying the source component 220 and overlay components 222.

Custom compositor development module 224 provides developers the ability to generate custom composition modules, such as custom composition module 132. Custom composition module 132 may be implemented as a plug-in component to media compositor 114 to extend the capabilities of media compositor 114 by giving developers the capability to create more complex media overlays, such as animated media overlays. For example, custom compositor development module 224 may include a background sample 228 along with overlay samples 230. The developer is then able to use the background sample 228 and the overlay samples 230 to create custom composition module 132, which may include, for example, custom parameters 232. For example, custom parameters 232 may associate individual frames of source component 220 with individual frames of one or more overlay components 222.

After the developer creates custom composition module 132, media composition application 218 may call the custom composition module 132 when generating a media composition. For example, media composition application 218 may provide media compositor 114 with source component 220 and overlay components 222 to be composed with source component 220. Media composition application 218 may specify that custom composition module 132 is to be used to generate the media composition, and accordingly, media composition application 218 may also provide values for the custom parameters 232. For example, like preconfigured composition module 130 discussed above, custom composition module 132 may generate a media composition by grouping multiple overlay components 222 into a single group (referred to as an overlay layer) and adding the overlay layer to source component 220 in a single processing step. In such an example, custom composition module 132 groups and adds overlay components 222 to source component 220 based on custom parameters 232.

When processing source component 220 and overlay components 222 to generate a media composition as discussed above, media compositor 114 may process one or more frames of source component 220 and/or one or more frames of overlay components 222 at a time. For example, media compositor 114 may process a first frame of source component 220 by adding one or more frames from overlay components 222 to the first frame of source component 220. Media compositor 114 determines the one or more frames of overlay components 222 to be added to the first frame of source component 220 based on overlay parameters 226 if media compositor 114 is using preconfigured composition module 130, or based on custom parameters 232 if media compositor 114 is using custom composition module 132. In an example, after processing the first frame of source component 220 with its corresponding frame from overlay components 222, media compositor 114 then processes a second frame of source component 220 with its corresponding frame from overlay components 222. Media compositor 114 will continue to process each frame of source component 220 with its corresponding frame from overlay components 222 until every frame of source component 220 that is required to generate the requested media composition has been processed.

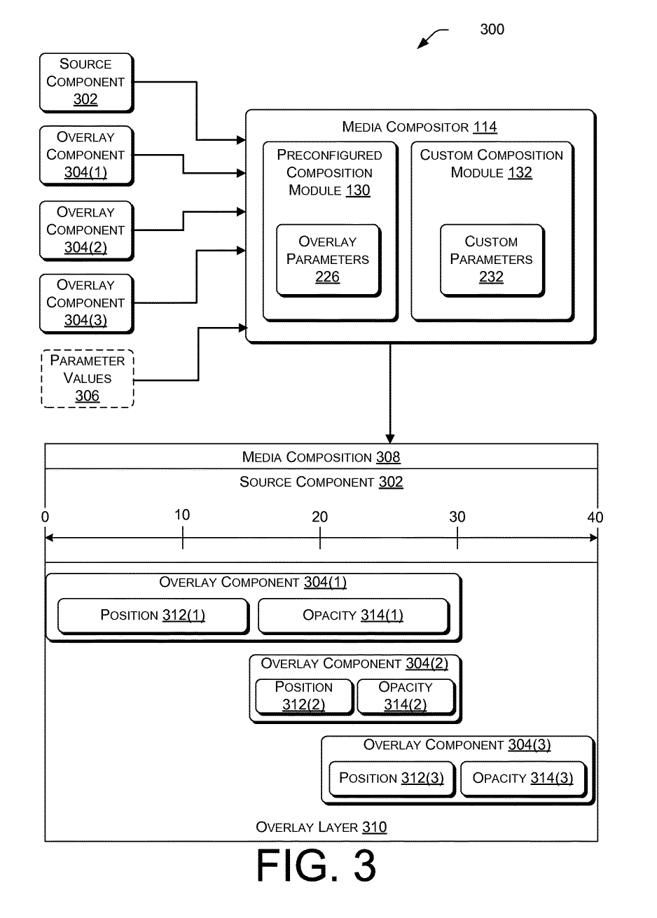

FIG. 3 illustrates an example pipeline 300 for implementing media composition using aggregate overlay layers. In the illustrated example, media compositor 114 receives source component 302, overlay component 304(1), overlay component 304(2), and overlay component 304(3). For example, a user may want to create a media composition that includes overlay components 304 composed with source component 302. As such, media compositor 114 receives each of source component 302 and overlay components 304 as input from a media composition application (e.g., media composition application 218 shown in FIG. 2) to compose the media composition. The media composition application may also provide parameter values 306. Alternatively, preconfigured composition module 130 may use pre-defined overlay parameters 226.

In one example, before media compositor 114 receives source component 302 and overlay components 304, one or more of source component 302 and/or overlay components 304 may be preprocessed. For example, each of source component 302 and overlay components 304 may be preprocessed using trim processing (not shown) and color space converter processing (not shown).

In response to receiving source component 302 and overlay components 304, preconfigured composition module 130 or custom composition module 132 generates a media composition 308 by grouping overlay components 304 together, where overlay layer 310 represents the grouping of overlay components 304(1), 3014(2), and 304(3). The composition module then adds overlay layer 310 to source component 302 in a single processing step.

In the illustrated example, if preconfigured composition module 130 generates media composition 308, the media composition 308 may be based on overlay parameters 226, which may be specified according to parameter values 306. For instance, overlay parameters 226 may specify that overlay component 304(1) is to be placed at position 312(1) over source component 302 with opacity 314(1), overlay component 304(2) is to be placed at position 312(2) over source component 302 with opacity 314(2), and overlay component 304(3) is to be placed at position 312(3) over source component 302 with opacity 314(3). Additionally, overlay parameters 226 may specify a timing for when each of overlay components 304 is to be composed with source component 302, which is illustrated by the size and position of overlay components 304 within overlay layer 310, relative to the timeline 316 shown in association with source component 202.

Alternatively, if custom composition module 132 generates the media composition 308, the media composition 308 may be based on custom parameters 232. For instance, custom parameters 232 may specify that overlay component 304(1) is to be placed at position 312(1) over source component 302 with opacity 314(1), overlay component 304(2) is to be placed at position 312(2) over source component 302 with opacity 314(2), and overlay component 304(3) is to be placed at position 312(3) over source component 302 with opacity 314(3). Additionally, custom parameters 232 may specify a timing for when each of overlay components 304 is to be composed with source component 302, which is illustrated by the size and position of overlay components 304 within overlay layer 310, relative to the timeline 316 shown in association with source component 202.

After generating media composition 308, pipeline 300 may further include performing additional processing to media composition 308 (not shown) and finally rendering media composition 308 (not shown).

It should be noted that the example pipeline 300 of FIG. 3 only illustrates grouping overlay components 304 together in a single overlay layer 310. However, in some examples, media compositor 114 may receive source component 302, overlay component 304(1), overlay component 304(2), overlay component 304(3), and one or more additional overlay components (not shown). In such examples, preconfigured composition module 130 and/or custom composition module 132 can generate media composition 308 by grouping the received overlay components together using two or more overlay layers and adding the two or more overlay layers to source component 302 in one or more processing steps.

For instance, preconfigured composition module 130 and/or custom composition module 132 can generate media composition 308 by grouping overlay component 304(1), overlay component 304(2), and overlay component 304(3) in overlay layer 310 and grouping at least two additional overlay components in a second overlay layer (not shown). Preconfigured composition module 130 and/or custom composition module 132 can then add overlay layer 110 to source component 302 in a first processing step and add the second overlay layer to source component 302 in a second processing step.

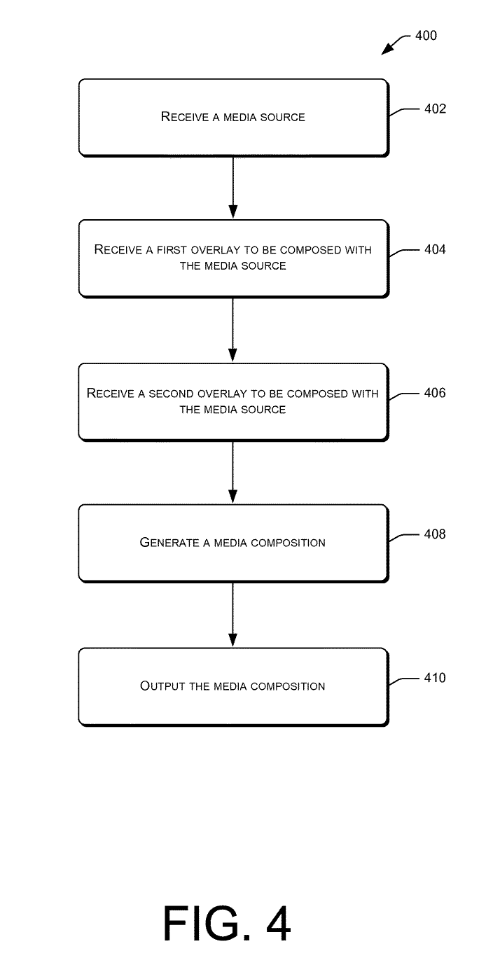

FIG. 4 illustrates an example process 400 for performing media composition using aggregate overlay layers. The process is illustrated as a set of operations shown as discrete blocks. The process may be implemented in any suitable hardware, software, firmware, or combination thereof. The order in which the operations are described is not to be construed as a limitation.

At block 402, media compositor 114 receives a media source. For example, media compositor 114 receives source component 220. As discussed above, source component 220 may include a video, an image, a graphics texture, a color, text, or the like.

At block 404, media compositor 114 receives a first overlay to be composed with the media source. For example, media compositor 114 may receive overlay component 222(1) to be composed with source component 220. As discussed above, overlay component 222(1) may include a video, an image, a graphic, a color, text, or the like.

At block 406, media compositor 114 receives a second overlay to be composed with the media source. For example, media compositor 114 may receive overlay component 222(2) to be composed with source component 220. As discussed above, overlay component 222(2) may also include a video, an image, a graphic, a color, text, or the like.

At block 408, media compositor 114 generates a media composition that includes the first overlay and the second overlay composed with the media source. For example, media compositor 114 generates a media composition 308 that includes multiple overlay components 304 within a single overlay layer 310 composed with the source component 302. As discussed above, media compositor 114 groups multiple overlay components together as a single overlay layer (illustrated in FIG. 3 as overlay layer 310), and adds the overlay layer to source component 302 in a single processing step.

At block 410, media compositor 114 outputs the media composition. For example, media compositor 114 returns the generated media composition 308 to the media composition application 218.

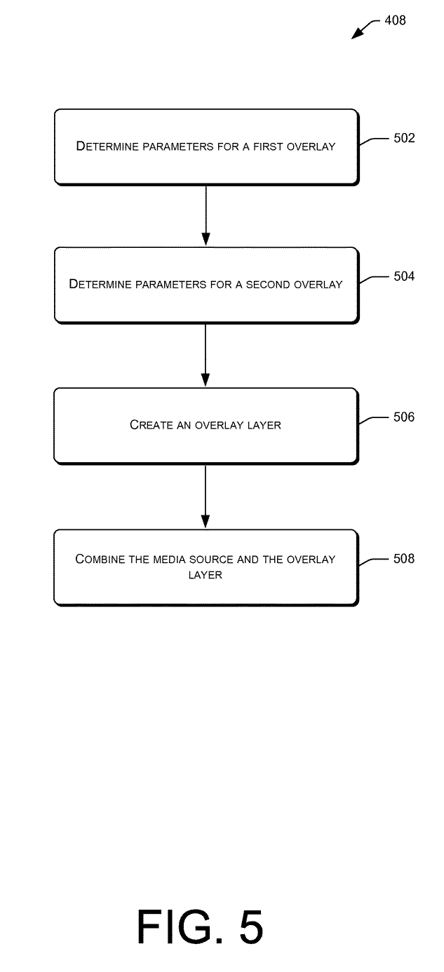

FIG. 5 illustrates an example process 408 for generating a media composition. The process is illustrated as a set of operations shown as discrete blocks. The process may be implemented in any suitable hardware, software, firmware, or combination thereof. The order in which the operations are described is not to be construed as a limitation.

At block 502, media compositor 114 determines parameter values for the first overlay. At block 504, media compositor 114 determines parameter values for the second overlay. For example, preconfigured composition module 130 may use pre-defined overlay parameters 226. Alternatively, preconfigured composition module 130 or custom composition module 132 may receive user-specified parameter values 306. As discussed above, the parameters may include any combination of a timing, a position, and/or an opacity.

At block 506, media compositor 114 creates an overlay layer. For example, media compositor 114 combines the first overlay and the second overlay to create a single overlay layer that includes both the first overlay and the second overlay arranged together according to the determined overlay parameters.

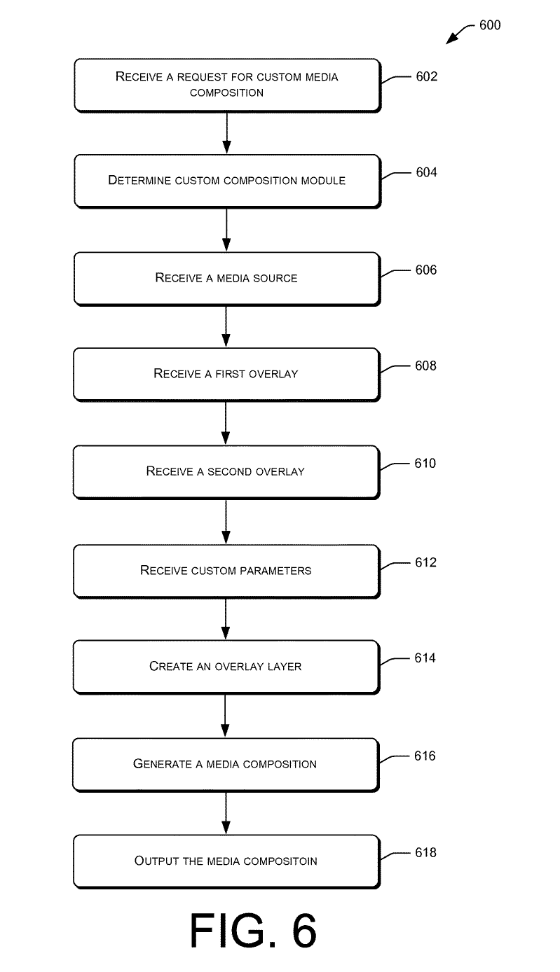

At block 508, media compositor 114 combines the media source and the overlay layer to generate the media composition. FIG. 6 illustrates an example process 600 for performing custom media composition. The process is illustrated as a set of operations shown as discrete blocks. The process may be implemented in any suitable hardware, software, firmware, or combination thereof. The order in which the operations are described is not to be construed as a limitation.

At block 602, media compositor 114 receives a request for custom media composition. For example, media compositor 114 may receive a request from media composition application 218.

At block 604, media compositor determines a custom composition module. For example, media compositor 114 may determine custom composition module 132 based on the request from the media composition application 218.

At block 606, media compositor 114 receives a media source. For example, media compositor 114 receives source component 220. As discussed above, source component 220 may include a video, an image, a graphic, a color, text, or the like.

At block 608, media compositor 114 receives a first overlay to be composed with the media source. For example, media compositor 114 may receive overlay component 222(1) to be composed with source component 220. As discussed above, overlay component 222(1) may include a video, an image, a graphic, a color, text, or the like.

At block 610, media compositor 114 receives a second overlay to be composed with the media source. For example, media compositor 114 may receive overlay component 222(2) to be composed with source component 220. As discussed above, overlay component 222(2) may also include a video, an image, a graphic, a color, text, or the like.

At block 612, media compositor 114 receives custom parameters. For example, media compositor 114 may receive custom parameters values 306 from media composition application 218. Custom parameters 232 may include, for example, any combination of a timing, a position, and/or an opacity for overlays.

At block 614, media compositor 114 creates an overlay layer. For example, custom composition module 132 combines the first overlay and the second overlay to create a single overlay layer that includes both the first overlay and the second overlay arranged together according to the determined overlay parameters.

At block 616, media compositor 114 generates a media composition that includes the first overlay and the second overlay composed with the media source. For example, custom composition module 132 generates a media composition 308 that includes multiple overlay components 304 within a single overlay layer 310 composed with the source component 302. As discussed above, custom composition module 132 groups multiple overlay components together as a single overlay layer (illustrated in FIG. 3 as overlay layer 310) based on custom parameters, and adds the overlay layer to source component 302 in a single processing step.

At block 618, media compositor 114 outputs the media composition. For example, media compositor 114 returns the generated media composition 308 to the media composition application 218.

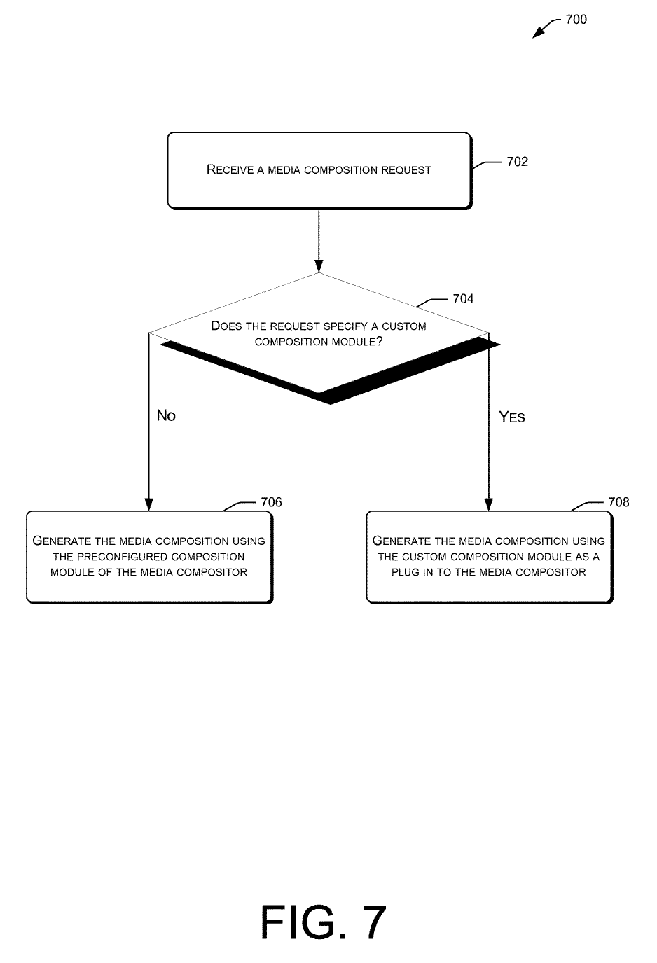

FIG. 7 illustrates an example process 700 for processing a request to generate a media composition using a media compositor. The process is illustrated as a set of operations shown as discrete blocks. The process may be implemented in any suitable hardware, software, firmware, or combination thereof. The order in which the operations are described is not to be construed as a limitation.

At block 702, media compositor 114 receives a media composition request. For example, media compositor 114 receives a request from media composition application 218.

At block 704, media compositor 114 determines a composition module to process the request. For example, media composition application 218 may indicate whether media composition application 218 wants to use preconfigured composition module 130 or a custom composition module 132 in the media composition request.

If media compositor 114 determines that the request does not specify a custom composition module (the “No” branch from block 704), then at block 706, media compositor 114 generates the requested media composition using the preconfigured composition module 130 of media compositor 114.

On the other hand, if media compositor 114 determines that the media composition request is directed to a custom composition module (the “Yes” branch from block 704), then at block 708, media compositor 114 directs the request to the custom composition module specified in the request (e.g., a custom composition module that has previously been developed in conjunction with the media composition application 218, or perhaps in conjunction with another media composition application), and media compositor 114 generates the media composition using the custom composition module as a plug in to media compositor 114. For example, media compositor 114 may generate media composition 308 using custom composition module 132 as a plug in to media compositor 114.

### Example Clauses

A: A method comprising: receiving a media source; receiving a first overlay to be composed with the media source; receiving a second overlay to be composed with the media source; grouping the first overlay with the second overlay to form an overlay layer; and generating an output media composition that includes the first overlay and the second overlay composed with the media source, wherein the output media composition is generated by adding the overlay layer to the media source in a single processing step.

B: A method as paragraph A recites, wherein the first overlay and the second overlay are grouped based on a processing pattern to be applied to both the first overlay and the second overlay.

C: A method as either paragraph A or paragraph B recites, further comprising: receiving a first parameter value for the first overlay; and receiving a second parameter value for the second overlay, wherein the first overlay is composed with the media source based at least in part on the first parameter value and the second overlay is composed with the media source based at least in part on the second parameter value.

D: A method as paragraph C recites, wherein the first parameter value specifies at least one of: a position for the first overlay to be composed on the media source; a timing for the first overlay to be composed on the media source; or an opacity for the first overlay.

E: A method as any one of paragraphs A-D recites, further comprising: receiving a third overlay to be composed with the media source; receiving a fourth overlay to be composed with the media source; grouping the third overlay and the fourth overlay to form a second overlay layer; and generating the output media composition to further include the third overlay and the fourth overlay composed with the media source, wherein the output media composition is further generated by adding the first overlay layer to the media source in a first processing step to generate an intermediate media composition; and adding the second overlay layer to the intermediate media composition in a second processing step to generate the output media composition.

F: A method as paragraph E recites, wherein: the first overlay and the second overlay are grouped based on a first processing pattern to be applied to both the first overlay and the second overlay; and the third overlay and the fourth overlay are grouped based on a second processing pattern to be applied to both the third overlay and the fourth overlay.

G: A computer-readable medium having computer-executable instructions thereon, the computer-executable instructions configured to perform a method as any one of paragraphs A-F recites.

H: A device comprising: a computer-readable media having computer-executable instructions thereon to configure a computer to perform a method as any one of paragraphs A-F recites, the processing unit adapted to execute the instructions to perform the method as any one of paragraphs A-F recites.

I: A device comprising: a computer-readable media; one or more processing units coupled to the computer-readable media; and a media compositor stored in the computer-readable media and executable by the one or more processing units, the media compositor configured to: receive a media source; receive a first overlay to be composed with the media source; receive a second overlay to be composed with the media source; determine parameter values for the first overlay and the second overlay; and generate an output media composition that includes the first overlay and the second overlay composed with the media source, wherein the output media composition is generated by adding, based at least in part on the parameter values, the first overlay and the second overlay to the media source in a single processing step.

J: A device as paragraph I recites, the parameter values include a first parameter value for the first overlay and a second parameter value for the second overlay; the first overlay is composed with the media source based at least in part on the first parameter value; and the second overlay is composed with the media source based at least in part on the second parameter value.

K: A device as either paragraph I or J recites, wherein the parameter values specify one or more of a first position for the first overlay to be composed on the media source; a first timing for the first overlay to be composed on the media source; a first opacity for the first overlay; a second position for the second overlay to be composed on the media source; a second timing for the second overlay to be composed on the media source; and a second opacity for the second overlay.

L: A device as any one of paragraphs I-K recites, wherein the media compositor includes a preconfigured composition module to generate the output media composition according to a pre-defined processing pattern.

M: A device as any one of paragraphs I-K recites, wherein the media compositor includes a custom compositor development module configured to: receive data defining a custom processing pattern; and create a custom composition module based at least in part on the custom processing pattern.

N: A device as paragraph M recites, wherein the media compositor further includes the custom composition module to generate the output media composition according to the custom processing pattern.

O: A device as paragraph N recites, wherein the parameter values include a value for a custom parameter defined in association with the custom processing pattern.

P: A device as any one of paragraphs I-O recites, wherein the media source includes a video; the first overlay includes at least one of another video, an image, a color, or a text; and the second overlay includes at least one of another video, an image, a color, or a text.

Q: A device as any one of paragraphs I-P recites, wherein the media source includes a video comprising a plurality of frames; and the output media composition is further generated by processing individual frames of the plurality of frames of the media source.

R: One or more computer-readable media storing computer-executable instructions that, when executed on one or more processors, configure a computer to perform acts comprising: receiving a plurality of frames of a media source; receiving a first overlay; receiving a second overlay; determining that the first overlay and the second overlay are to be applied to the media source according to a first processing pattern; based at least in part on the determining, grouping the first overlay and the second overlay to form a first overlay layer; and in a single processing step, applying the first overlay layer to the media source to generate an output media composition.

S: The one or more computer-readable media as paragraph R recites, wherein the first processing pattern is a pre-defined processing pattern.

T: The one or more computer-readable media as paragraph S recites, wherein the pre-defined processing pattern has an associated parameter, the acts further comprising: determining a parameter value associated with the first overlay; determining a parameter value associated with the second overlay; applying the first overlay layer to the media source to generate an output media composition by: applying the first overlay to the media source according to the parameter value associated with the first overlay; and applying the second overlay to the media source according to the parameter value associated with the second overlay.

U: The one or more computer-readable media as paragraph R recites, wherein the first processing pattern is a custom processing pattern.

V: The one or more computer-readable media as paragraphs U recites, wherein the custom processing pattern has an associated custom parameter, the acts further comprising: the custom processing pattern has an associated custom parameter, the acts further comprising: determining a custom parameter value associated with the second overlay; applying the first overlay layer to the media source to generate an output media composition by: applying the first overlay to the media source according to the custom parameter value associated with the first overlay; and applying the second overlay to the media source according to the custom parameter value associated with the second overlay.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 106, 120, and/or 200 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving a media source;
receiving a first overlay to be composed with the media source;
receiving a second overlay to be composed with the media source;
grouping the first overlay with the second overlay to form an overlay layer; and
generating an output media composition that includes the first overlay and the second overlay composed with the media source, wherein the output media composition is generated by adding the overlay layer to the media source in a single processing step.

2. A method as recited in claim 1, wherein the first overlay and the second overlay are grouped based on a processing pattern to be applied to both the first overlay and the second overlay.

3. A method as recited in claim 1, further comprising:
receiving a first parameter value for the first overlay; and
receiving a second parameter value for the second overlay,
wherein the first overlay is composed with the media source based at least in part on the first parameter value and the second overlay is composed with the media source based at least in part on the second parameter value.

4. A method as recited in claim 3, wherein the first parameter value specifies at least one of:
a position for the first overlay to be composed on the media source;
a timing for the first overlay to be composed on the media source; or
an opacity for the first overlay.

5. A method as recited in claim 1, further comprising:
receiving a third overlay to be composed with the media source;
receiving a fourth overlay to be composed with the media source;
grouping the third overlay and the fourth overlay to form a second overlay layer; and
generating the output media composition to further include the third overlay and the fourth overlay composed with the media source, wherein the output media composition is generated by:
adding the first overlay layer to the media source in a first processing step to generate an intermediate media composition; and
adding the second overlay layer to the intermediate media composition in a second processing step to generate the output media composition.

6. A method as recited in claim 5, wherein:
the first overlay and the second overlay are grouped based on a first processing pattern to be applied to both the first overlay and the second overlay; and
the third overlay and the fourth overlay are grouped based on a second processing pattern to be applied to both the third overlay and the fourth overlay.

7. A device comprising:
a computer-readable media;
one or more processing units coupled to the computer-readable media; and
a media compositor stored in the computer-readable media and executable by the one or more processing units, the media compositor configured to:
receive a media source;
receive a first overlay to be composed with the media source;
receive a second overlay to be composed with the media source;
determine parameter values for the first overlay and the second overlay; and
generate an output media composition that includes the first overlay and the second overlay composed with the media source, wherein the output media composition is generated by adding, based at least in part on the parameter values, the first overlay and the second overlay to the media source in a single processing step.

8. A device as recited in claim 7, wherein:
the parameter values include a first parameter value for the first overlay and a second parameter value for the second overlay;
the first overlay is composed with the media source based at least in part on the first parameter value; and
the second overlay is composed with the media source based at least in part on the second parameter value.

9. A device as recited in claim 7, wherein the parameter values specify one or more of:
a first position for the first overlay to be composed on the media source;
a first timing for the first overlay to be composed on the media source;
a first opacity for the first overlay;
a second position for the second overlay to be composed on the media source;
a second timing for the second overlay to be composed on the media source; and
a second opacity for the second overlay.

10. A device as recited in claim 7, wherein the media compositor includes a preconfigured composition module to generate the output media composition according to a pre-defined processing pattern.

11. A device as recited in claim 7, wherein the media compositor includes a custom compositor development module configured to:
receive data defining a custom processing pattern; and
create a custom composition module based at least in part on the custom processing pattern.

12. A device as recited in claim 11, wherein the media compositor further includes the custom composition module to generate the output media composition according to the custom processing pattern.

13. A device as recited in claim 12, wherein the parameter values include a value for a custom parameter defined in association with the custom processing pattern.

14. A device as recited in claim 7, wherein:
the media source includes a video;
the first overlay includes at least one of another video, an image, a color, or a text; and
the second overlay includes at least one of another video, an image, a color, or a text.

15. A device as recited in claim 7, wherein:
the media source includes a video comprising a plurality of frames; and
the output media composition is further generated by processing individual frames of the plurality of frames of the media source.

16. One or more computer-readable media storing computer-executable instructions that, when executed on one or more processors, configure a computer to perform acts comprising:
receiving a plurality of frames of a media source;
receiving a first overlay;
receiving a second overlay;
determining that the first overlay and the second overlay are to be applied to the media source according to a first processing pattern;
based at least in part on the determining, grouping the first overlay and the second overlay to form a first overlay layer; and
in a single processing step, applying the first overlay layer to the media source to generate an output media composition.

17. One or more computer-readable media as recited in claim 16, wherein the first processing pattern is a pre-defined processing pattern.

18. One or more computer-readable media as recited in claim 17, wherein the pre-defined processing pattern has an associated parameter, the acts further comprising:
determining a parameter value associated with the first overlay;
determining a parameter value associated with the second overlay;
applying the first overlay layer to the media source to generate an output media composition by:
applying the first overlay to the media source according to the parameter value associated with the first overlay; and
applying the second overlay to the media source according to the parameter value associated with the second overlay.

19. One or more computer-readable media as recited in claim 16, wherein the first processing pattern is a custom processing pattern.

20. One or more computer-readable media as recited in claim 19, wherein the custom processing pattern has an associated custom parameter, the acts further comprising:
determining a custom parameter value associated with the first overlay;
determining a custom parameter value associated with the second overlay;
applying the first overlay layer to the media source to generate an output media composition by:
applying the first overlay to the media source according to the custom parameter value associated with the first overlay; and
applying the second overlay to the media source according to the custom parameter value associated with the second overlay.
